(19) United States
(12) Patent Application Publication
(10) Pub. No.: US 2009/0159065 A1
(43) Pub. Date: Jun. 25, 2009

(54) Pneumatic spear gun

(76) Inventor: Christopher Bruce Moffitt, Depew, OK (US)

Correspondence Address: MCHALE & SLAVIN, P.A., 2855 PGA BLVD, PALM BEACH GARDENS, FL, 33410, US

(21) Appl. No.: 11/962,829

(22) Filed: Dec. 21, 2007

(51) Int. Cl. A01K 81/04; F41B 11/00

(52) U.S. Cl. 124/71; 43/6

(57) ABSTRACT

A pneumatic spear gun has a stock supporting a barrel. The gun uses compressed gas to power a spear having movable vanes that slide along the shaft to become fixed at the base of the spear to rotate the spear and stabilize trajectory. The compressed gas is stored in a high pressure tank in the forearm of the gun. The tank also has a breathing regulator and mouthpiece. There is a gas handling system between the tank and the barrel for providing multiple single shots and regulating the flow of expanding gases.

### FIELD OF THE INVENTION

This invention relates to the field of spear fishing. The invention also includes features useful for underwater emergencies or extending dive time.

### BACKGROUND OF THE INVENTION

Spear fishing is probably one of the oldest forms of fishing. With the advent of self contained underwater breathing apparatus (SCUBA), divers were able to remain in the underwater habitat to search out and see their prey. The power driving the spear has evolved from the hand-held spear through the Hawaiian sling with resilient bands to compressed gases, such as C02 or air. The spear guns using compressed gases are less cumbersome, require less effort, and permit more rapid firing than the earlier devices.

Most of the guns are not equipped with a sighting system for improved accuracy. Since the range to the target is usually fairly short, the diver merely points and shoots.

In general, the spear guns are muzzle loaded and have multiple barrels for multiple shots without reloading. The spears fired by the guns may be tethered to the gun or diver or may be untethered. The use of a tether is determined by either the type of fish being hunted or the locale. Tethered spears are desirable in reef fishing to retrieve the spear and/or the fish from restricted areas too small for a diver to enter. Some of the conventional spear guns have a safety mechanism, while other guns do not have safeties.

Kenaio, U.S. Pat. No. 4,019,480, discloses a pneumatic spear gun with a mechanical safety that physically blocks the movement of the trigger when in the safe position.

U.S. Pat. No. 4,660,315 discloses a spear gun that uses the diver's breathing gas as the source of power. Obviously, the number of shots taken directly reduces the underwater time of the diver. Further, the dive tank must be modified to provide another valved outlet to the tank and any malfunction of that valve could lead to the depletion of the diver's air.

Ekstrom, U.S. Pat. No. 5,086,749, teaches a C02 powered gun using a hollow spear that is telescoped over a tubular barrel shaft. The compressed gas is released near the forward end of the barrel and the shaft serves to guide the spear as it is fired.

U.S. Pat. No. 5,595,166 to Schmidt III et al discloses a double barreled spear gun with improved accuracy. Each spear fired by the gun may be untethered or is tethered with a fixed or spooled length tether. The gun may be side loaded rather than muzzle loaded. The muzzles are adapted to break away from the remainder of the gun. The spear is powered by resilient bands released by the trigger associated with the barrel being fired. Each trigger has a safety mechanism or lock.

Horlock, U.S. Pat. No. 6,170,477, discloses a pneumatic spear gun in which the spear acts as a compressing piston in the barrel as it is loaded into the firing position. The gun also has a sealed pneumatic chamber containing air that is compressed by a manual pump forcing sea water against a movable chamber wall.

What is needed in the art is a pneumatic spear gun having a small tank of highly compressed gas with a system to isolate and reduce the pressure for each shot including a regulator which may also be used by the diver. The spear gun has increased accuracy provided by a sighting system and spears with movable vanes for stabilized trajectory.

### SUMMARY OF THE INVENTION

Disclosed is a pneumatic spear gun that employs compressed gas to power a spear. The spear has movable vanes that slide along the shaft to become fixed at the base of the spear to rotate the spear and stabilize trajectory. The compressed gas is stored in a high pressure tank in the fore arm of the gun. The tank also has a breathing regulator and mouthpiece. There is a gas handling system between the tank and the barrel for providing multiple single shots and regulating the flow of expanding gases.

Accordingly, an objective of this invention is to provide a spear gun having a source of highly compressed gas connected to a barrel by a pressure control system that automatically reduces the pressure and permits multiple shots.

It is a further objective of this invention is to provide an ergonomically shaped spear gun for accurate aiming without interference with breathing equipment. It is also an objective to provide laser sighting to improve accuracy of the spear gun.

It is still another objective of this invention to provide breathable gas in the source of highly compressed gas and a regulator to permit breathing of that source of gas.

It is yet another objective of this invention to provide a safety mechanism to prevent inadvertent discharge of the spear gun by actuation of the trigger, alone.

It is another objective of this invention to provide a spear which cooperates with the spear gun to improve trajectory and accuracy.

Other objectives and advantages of this invention will become apparent from the following description taken in conjunction with the accompanying drawing wherein are set forth, by way of illustration and example, certain embodiments of this invention. The drawings constitute a part of the specification and include exemplary embodiments of the present invention and illustrate various objectives and features thereof.

### BRIEF DESCRIPTION OF THE DRAWINGS

FIG. 1 is a side perspective of the spear gun;

FIG. 2 is a top view of the spear gun;

FIG. 3 is a side view, partially in section, of the spear gun;

FIG. 4A is an enlarged sectional view of the firing mechanism and safety of the spear gun;

FIG. 4B is a sectional view of FIG. 4A showing trigger movement;

FIG. 5A is a top detail sectional view of the safety in position to fire the left barrel with right barrel safe;

FIG. 5B is a top detail sectional view of the safety in safe position for both barrels;

FIG. 5c is a top detail sectional view of the safety in position to fire the right barrel with the left barrel safe;

FIG. 6A is a partial sectional view of the barrel with a spear in place;

FIG. 6B is a perspective of a spear of this invention with the transitional position of the vanes in phantom lines;

FIG. 7 is a perspective of the spear with tether ring and vanes; and

FIG. 8 is an end view, partially in section, of the spear and vanes of this invention.

### DETAILED DESCRIPTION OF THE INVENTION

Although the invention will be described in terms of a specific embodiment, it will be readily apparent to those skilled in this art that various modifications, rearrangements and substitutions can be made without departing from the spirit of the invention. The scope of the invention is defined by the claims appended hereto.

Now referring to the drawings, the spear gun 10 of the instant invention resembles a field gun in that it is composed of a stock 11 with a butt 12 and a forearm. The stock supports at least one barrel 13 along the upper surface but, as shown, there are two barrels 13 and 13′. Also, as shown, the barrels are side-by-side but could be oriented as an over-and-under double barrel. The butt 12 is joined to the forearm by a breech section of the stock in which the trigger 17 is mounted protected by a trigger guard 16. The stock 11 is ergonomically formed to permit the gun to be sighted, by the diver, without interference with breathing equipment. A high pressure tank 19 is mounted in the fore arm of the stock 11. A high pressure line 26, 27 connects the tank 19 with the closed end of the barrel to provide power to launch the spear 14. A laser light source 29 is mounted in the front end of the fore arm to provide target acquisition in pointing the spear gun. The laser light is powered by batteries, not shown.

The stock is made of wood, preferably, though other materials are a matter of choice. It is desired that the stock has positive buoyancy such that the entire weapon has neutral buoyancy underwater for ease of carrying and deployment. The front end of the fore arm also has a cavity 31 to house a stored tether 30.

In normal operation, the spear gun is carried with a spear 14 in the barrel or two spears 14, 14′ in the barrels 13, 13′. The spear 14 has a sharpened leading end with or without a barb. The barb 60 may be fixed or pivoting, as shown, on the spear shaft. The spear is of a length to extend beyond the barrel, approximately 6 inches.

Mounted on the breech portion of the stock is a safety 18 which, in the safe position, prevents firing of the spear even though the trigger is pulled. In the double barreled gun, the safety 18 has a three-way position to fire either barrel or neither, as shown in FIGS. 3, 4A, and 5A-C. The safety is in the form of a rotary valve between high pressure lines 26 and 27 connecting the trigger mechanism and the barrel.

The high pressure tank 19 is the source of power for launching the spear with a velocity sufficient to penetrate most game fish within range. The range is dependent on the diving depth and ambient pressure. The tank 19 fits smoothly in the fore arm of the spear gun and may contain various gases, with compressed air being preferred, at a pressure of approximately 3,000 to 5,000 psi. The tank has a conventional breathing regulator 20 connected to one outlet. The regulator 20 includes a refill valve and a visual pressure gauge. The regulator 20 has a mouthpiece 21 to allow the diver to breathe from the tank.

The tank 19 has a second outlet connected to the barrel(s) for propelling a spear. The second outlet has a high pressure line 26 that includes a high pressure regulator 22 connected to a flow fuse 23, an accumulator 24, the trigger 25 and the safety 18 thence through high pressure line 27 to the closed end(s) of the barrel(s). The high pressure regulator 22 is as Model 1247, marketed by Aqua Environment Corporation. The small piston type regulator has one outlet and operates with an inlet pressure of approximately 6,000 psi and an adjustable outlet pressure of 200-1,000 psi. It is self venting when the outlet pressure exceeds set pressure by 20-40%. For example, the outlet pressure for this spear gun may be set at 1,000 psi re of 1,200 to 1,400 psi.

The outlet of the regulator 22 is connected to the inlet of the pressure fuse 23, shown in FIG. 3. The pressure fuse 23 is a flow limiter that prevents damage to the accumulator 24 through uncontrolled filling. The pressure fuse may be a device similar to Fuse Model 443 marketed by Aqua Environment Corporation. The pressure fuse 23 has an inlet with a spring biased valve and an outlet connected to the inlet of the accumulator 24. The inlet pressure may be approximately 6,000 psi and the nominal flow rate to close the valve may be adjusted, e.g., a flow rate of 80 cfm at 5,000 psi can be adjusted downwardly. This provides a smooth graduated closing of the outlet of the fuse as the accumulator 24 fills for a shot. The fuse provides for a small leakage to keep the pressure in the accumulator at the set system pressure. As an alternate to the fuse, a simple restrictor may be used in the line.

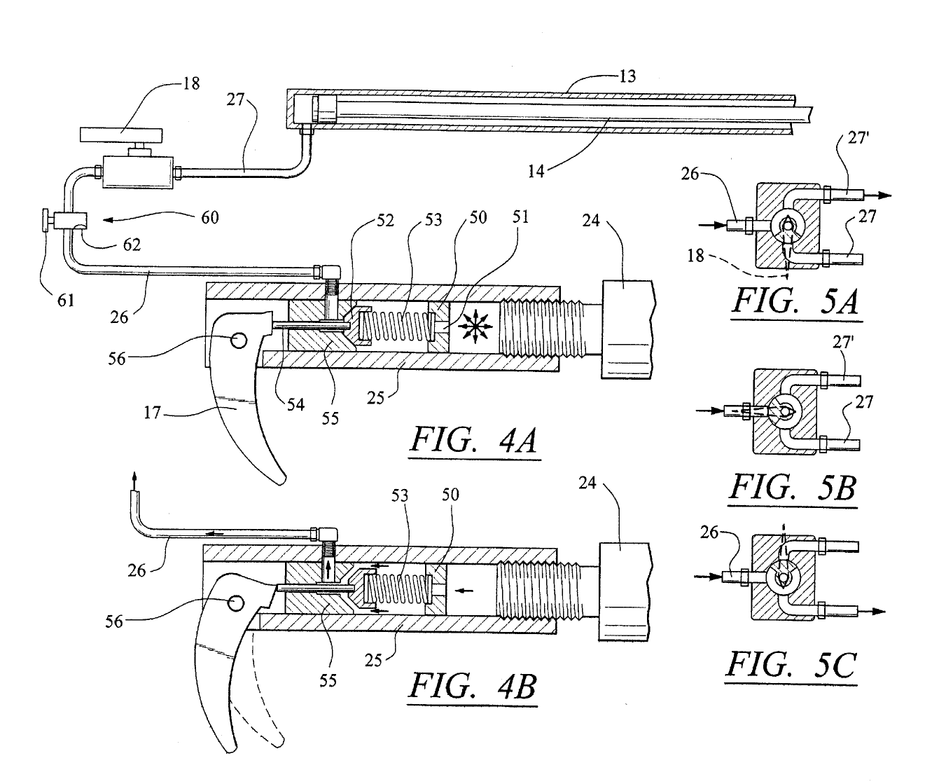

The accumulator 24 is a pressure reservoir with a capacity necessary for launching a spear with a force of 1,000 to 1,500 psi. The accumulator outlet is connected to the trigger valve 25, shown in FIGS. 4A and 4B.

The trigger valve 25 has a restriction plate 50 with an aperture 51 separated from the valve 52 by a spring 53. The valve 52 has a valve stem 54 extending through the valve seat 55 to engage the trigger 17. As the trigger 17 pivots about trigger pin 56, the valve stem 54 moves the valve 52 away from valve seat 55 to open the high pressure line 26 from the accumulator 24 to the safety 18. If the safety is in the all safe position, nothing happens but if the safety is set to fire a barrel the compressed gas enters the barrel to launch the spear. The spring biased restriction plate 50 cushions the explosive escape of the compressed gas.

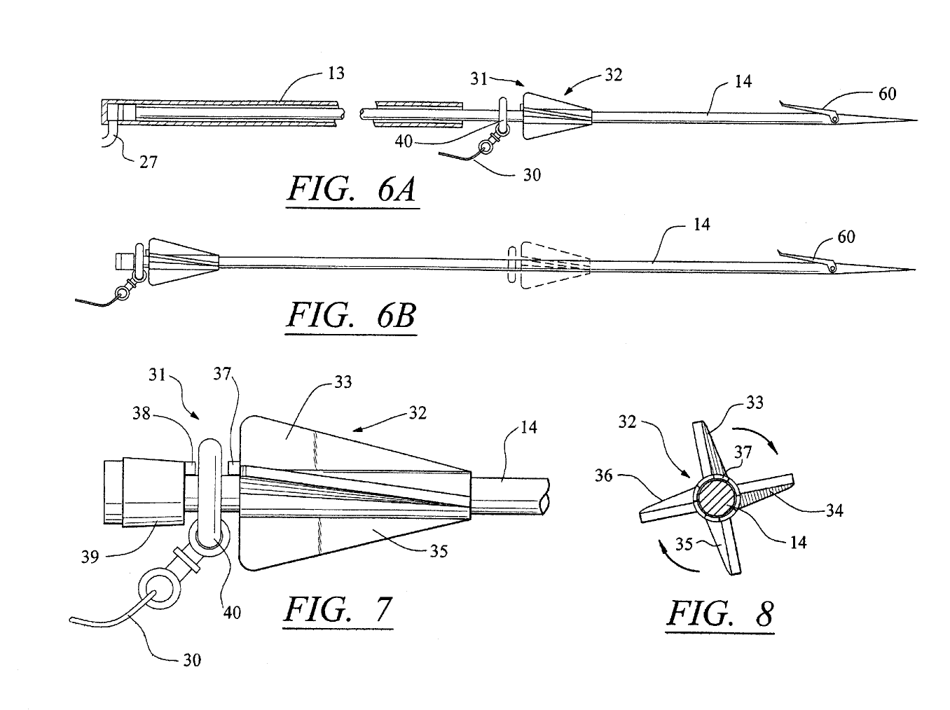

As shown in FIGS. 4A and 6A, the expanding gas is vented into the barrel(s) 13 between the closed end and the trailing end of the spear(s) 14 through high pressure line 27. The trailing end of the spear has an enlarged portion 39 which may be integrally formed or in the form of a grommet attached about the shaft. The enlarged portion acts as a piston to slide through the barrel and propel the spear. The enlarged portion has a cooperating locking mechanism 38 fixedly attached on the shaft. The locking mechanism may take one of several forms, such as a projection or detent. A tether ring 40 loosely encircles the shaft of the spear 14 between the enlarged end and the barb 60. The spear may be used with or without the tether ring. A tether 30 may be connected to the ring by any suitable connector, such as a knot, clip etc., and a length of the tether may be stored in the cavity 31. In front of the tether ring 40, guiding vanes 32 encircle the spear shaft. The vanes 32 have a tubular body with equally spaced wing-like projections 33, 34, 35, and 36 extending therefrom. The wings have a pitch or twist relative to the longitudinal axis of the shaft of the spear resulting from the base of the wings set at an angle, other than parallel, to the longitudinal axis of the tubular body. The tubular body of the vanes has a cooperating lock portion 37 on the rear of the vanes.

To load the gun, a spear is inserted into a barrel 13. Underwater the barrel is filled with water. To accomplish the seating of the spear, the barrel must be vented through a bleed valve. The bleed valve 60 is mounted in the high pressure line 26, shown in FIG. 4A, and has a selector knob 61 which is turned between an open and closed position. In the closed position, the high pressure line 26 is uninterrupted through the valve. In the open position, the high pressure line is blocked and the barrel 13, line 27, safety 18 are open to the ambient pressure through outlet 62. This permits expulsion of the fluid between the rear of the spear and the end of the barrel. Additionally, the safety must be switched to the barrel being loaded to provide an open pathway between each barrel and the outlet 62 when the valve 60 is open.

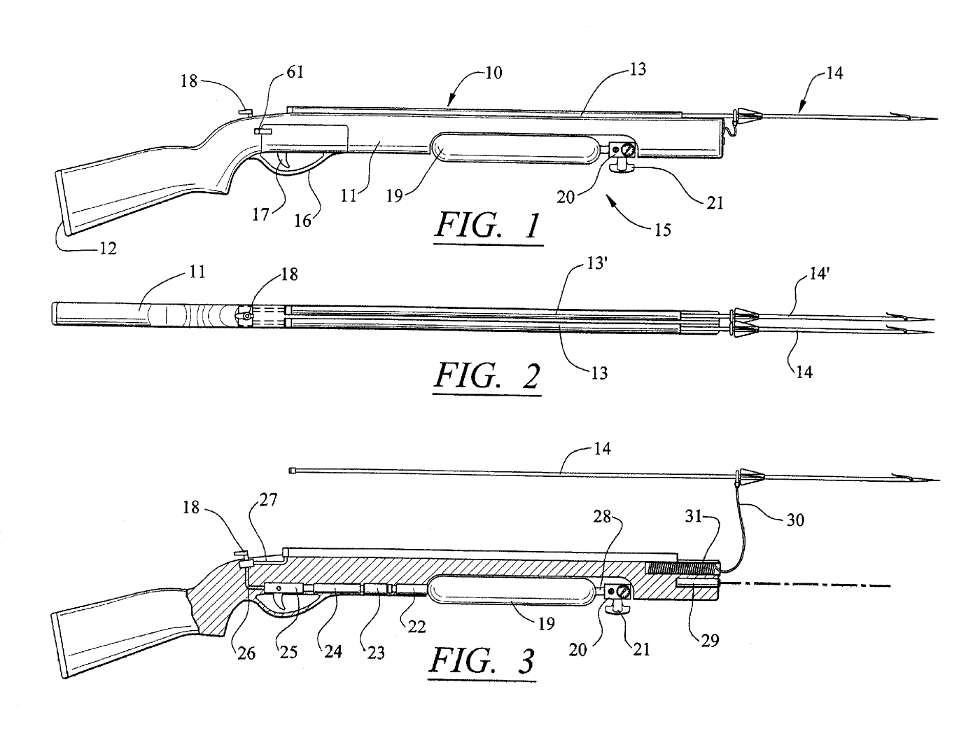

As the enlarged end of the spear is inserted into the muzzle of the barrel, the tether ring and the vanes contact the stock or barrel and will slide toward the sharpened end of the spear to be disposed as shown in FIG. 1. In use, the target will be illuminated by the laser, the safety will be turned to select a barrel and the trigger will be pulled. When the spear is launched by the expanding gas entering the barrel, the spear accelerates through the tether ring and vanes. As the vanes are carried through the water by the spear, they begin to rotate about the barrel and ultimately come to rest against the enlarged portion of the spear. Continued rotation will result in the cooperating lock mechanisms of the vanes and the enlarged portion becoming positively engaged so that the spear will rotate thereby stabilizing the trajectory.

A number of embodiments of the present invention have been described. Nevertheless, it will be understood that various modifications may be made without departing from the spirit and scope of the invention. Accordingly, it is to be understood that the invention is not to be limited by the specific illustrated embodiment but only by the scope of the appended claims.

What is claimed is:

1. A combination spear gun and removable spear for use by a diver in underwater fishing comprising a spear gun having an elongated stock with a butt adapted to engage the shoulder, a trigger adapted to be manipulated by one hand and a forearm adapted to be manipulated by the other hand, at least one barrel secured to said elongated stock, said at least one first barrel having a closed end and a open end, said open end terminating near said forearm and a removable elongated spear removably telescoped within said first barrel, said spear having a shaft with an enlarged end forming a piston frictionally contacting said closed end of said at least one barrel and a sharpened end, vanes slidably encircling said shaft between said sharpened end and said open end of said at least one barrel, a high pressure tank secured to said stock adapted to contain compressed gas, said tank having a first outlet, a breathing regulator operatively mounted on said first outlet, said breathing regulator connected to a mouthpiece for breathing the breathable gas, said tank including a second outlet connected to a high pressure gas line adapted to connect with said at least one barrel between said closed end and said enlarged end of said spear, a valve in said high pressure gas line adapted to connect said high pressure tank with said at least one barrel, said valve operatively connected with said trigger, whereby said breathing regulator may provide breathing gas and operation of said trigger mechanism can release said breathable gas from said accumulator into said barrel to launch a projectile causing said vanes to slide toward said enlarged end of said shaft to stabilize trajectory.

2. A personal safety system comprising a high pressure tank adapted to store breathable compressed gas at a first pressure, said tank having a first outlet, a breathing regulator operatively mounted on said first outlet, said breathing regulator connected to a mouthpiece for breathing the breathable gas, said tank including a second outlet, a pressure fuse operatively connected to said second outlet for controlled flow from said tank at a second lower pressure, an accumulator connected to said pressure fuse for storing said breathable compressed gas at said second lower pressure, a manually operated valve with an inlet fitted on said accumulator and an outlet connected to a tubular barrel, said barrel having a closed end and an open end, said valve having a closed position and an open position, said open position connecting said accumulator and said closed end of said barrel, said barrel adapted to frictionally engage a projectile at said closed end, and a trigger mechanism connected to said manual valve whereby operation of said trigger mechanism can release said breathable gas from said accumulator into said barrel to launch a projectile and said breathing regulator may provide breathing gas.

3. A personal safety system of claim 2 further comprising a stock, said stock supporting said barrel, said high pressure tank, said pressure fuse, said manual valve, said accumulator, and said trigger mechanism.

4. A pneumatic spear gun capable of multiple successive shots comprising a high pressure tank, said tank having an outlet connected to one end of a pneumatic line, said line having a second end connected to a first closed end of a first elongated barrel, said first elongated barrel having a second open end, said elongated barrel adapted to frictionally engage a spear extending from said closed end to said open end, a manual valve located in said pneumatic line between said tank and said first elongated barrel, said valve having a closed position and an open position, said open position of said valve connecting said tank and said first elongated barrel, a second elongated barrel aligned parallel with said first elongated barrel, said pneumatic line having a second branch between said manual valve and said second elongated barrel, a manual selector valve in said pneumatic line and said second branch, said manual selector valve having one position connecting said elongated barrel to said tank and another position connecting said second parallel barrel to said tank alternatively.

5. A pneumatic spear gun of claim 4 further comprising a trigger mechanism connected to said manual valve for facilitating manual activation of said valve.

6. A pneumatic spear gun of claim 4 further comprising a second elongated barrel aligned parallel with said first elongated barrel, said pneumatic line having a second branch between said manual valve and said second elongated barrel, a manual selector valve in said pneumatic line and said second branch, said manual selector valve having one position connecting said elongated barrel to said tank and another position connecting said second parallel barrel to said tank alternatively.

7. A pneumatic spear gun of claim 6 further comprising said manual selector valve having a closed position shutting said line and said branch line simultaneously.

8. A pneumatic spear gun of claim 6 further comprising said manual selector valve having a position connecting said line and said branch to said tank simultaneously.

9. A pneumatic spear gun capable of multiple successive shots comprising a high pressure tank, said tank having an outlet connected to one end of a pneumatic line, said line having a second end connected to a first closed end of an elongated barrel, said first elongated barrel having a second open end, said elongated barrel adapted to frictionally engage a spear extending from said closed end to said open end, a manual valve located in said pneumatic line between said tank and said first elongated barrel, said valve having a closed position and an open position, said open position of said valve connecting said tank and said first elongated barrel, a high pressure accumulator pneumatically connected to said line between said tank and said manual valve, said accumulator adapted to send a charge of compressed gas to said barrel upon activation of said manual valve, and a pressure fuse pneumatically connected in said line between said tank and said accumulator, said pressure fuse adapted to regulate flow from said tank into said accumulator, said pressure fuse biased to allow a predetermined flow therethrough upon a predetermined pressure differential between said accumulator and said tank.

10. A pneumatic spear gun of claim 9 further comprising a pressure fuse pneumatically connected in said line between said tank and said accumulator, said pressure fuse adapted to regulate flow from said tank into said accumulator, said pressure fuse biased to allow a predetermined flow therethrough upon a predetermined pressure differential between said accumulator and said tank.

11. A pneumatic spear gun capable of multiple successive shots comprising a high pressure tank, said tank having an outlet connected to one end of a pneumatic line, said line having a second end connected to a first closed end of an elongated barrel, said first elongated barrel having a second open end, said elongated barrel adapted to frictionally engage a spear extending from said closed end to said open end, a manual valve located in said pneumatic line between said tank and said first elongated barrel, said valve having a closed position and an open position, said open position of said valve connecting said tank and said first elongated barrel and a second outlet on said tank, said second outlet connected to a breathing regulator, said breathing regulator connected to a mouthpiece for emergency breathing.

12. A pneumatic spear gun of claim 11 further comprising a stock, said stock having a shoulder piece and a forearm, said tank, said pneumatic line, said valve and said barrel mounted on said stock between said shoulder piece and said forearm.

13. A pneumatic spear gun of claim 12 further comprising a line dispenser containing a length of line with a loose end, said loose end adapted to be connected to a spear, said line dispenser attached to said forearm.

14. A pneumatic spear gun of claim 13 further comprising a laser sight, said laser sight including a laser light source, said laser light source mounted in said forearm.

15. A pneumatic spear gun of claim 12 further comprising a laser sight, said laser sight including a laser light source, said laser light source mounted in said forearm.

16. A pneumatic spear gun of claim 12 further comprising said stock formed of a material having a positive buoyancy in water yielding a neutral buoyancy for said spear gun.

17. A pneumatic spear gun of claim 16 further comprising said stock formed of wood.

18. A spear adapted to be fired from a spear gun having a barrel, said spear comprising an elongated shaft with a butt end and a leading end, said butt end having an enlarged portion adapted to circumferentially engage said barrel, said spear having a first cooperating lock mechanism on said shaft near said enlarged portion, movable vanes on said shaft, said vanes including a ring encircling said shaft, said ring having equally spaced wings extending about the circumference thereof for stabilized trajectory, said ring including a second cooperating lock mechanism whereby when said spear is fired from a spear gun said vanes slide along said shaft and said first cooperating lock mechanism and said second cooperating lock mechanism engage and said wings stabilize the trajectory of said spear.

19. A spear of claim 18 further comprising a tether ring loosely encircling said shaft between said butt end and said vanes, said tether ring having a smaller diameter than said butt end, said tether ring adapted to be connected to a tether line whereby said shaft may rotate inside said tether ring and the tether line will remain untwisted.

20. A spear of claim 18 further comprising said wings each pitched at an angle to the longitudinal axis of said shaft whereby when said first cooperating lock mechanism and said second cooperating lock mechanism engage, said spear will rotate to stabilize the trajectory.
